(19) United States
(12) Patent Application Publication
(10) Pub. No.: US 2011/0316813 A1
(43) Pub. Date: Dec. 29, 2011

(54) OPTICAL TOUCH DISPLAY

(76) Inventors: Ren-Hau Gu, Hsin-Chu City (TW); Chih-Hsin Lin, Hsin-Chu City (TW); Hsin-Chia Chen, Hsin-Chu City (TW); Yu-Hao Huang, Hsin-Chu City (TW); Shu-Sian Yang, Hsin-Chu City (TW); Tzung-Min Su, Hsin-Chu City (TW)

(21) Appl. No.: 12/939,173

(22) Filed: Nov. 4, 2010

(30) Foreign Application Priority Data
Jun. 23, 2010 (TW) 099120509

(51) Int. Cl. G06F 3/042

(52) U.S. Cl. 345/175

(57) ABSTRACT

When an object touches a touch panel, a projection light source projects a predetermined image including image information and forms an object image having the image information on a surface of the object. An image sensor captures a reflection image including the object image. Then, an angle is calculated according to an image location of the object in the reflection image and a relative position of predetermined axis, and a distance between the object and the image sensor is calculated by comparing the predetermined image with the location, size and/or phase of the image information of the reflection image so as to determine a coordinate of the object on the touch panel according to the angle and the distance.

### BACKGROUND OF THE INVENTION

1. Field of the Invention

The present invention relates to optical touch displays, and more particularly to an optical touch display that utilizes an image sensor and a projection light source to obtain an object touch position.

2. Description of the Prior Art

An optical touch display utilizes blocking of light signals to determine position of a touch point. The optical touch display has a plurality of light signal receivers and a plurality of light signal emitters installed on borders of a touch panel. The light signal emitters arranged on the touch panel borders emit light signals simultaneously or in turns. When an object obstructs a light signal, a microprocessor analyzes signals received by the plurality of light signal receivers to position the touch point. Then, the signal corresponding to the touch position is transmitted to a device and processor controlling the touch panel. Finally, the touch panel displays position of the touch point contacted by the object, or executes a function corresponding to the touch point.

Because the prior art utilizes blocking of a light signal path to position the touch point, number of unique touch points that may be detected by the touch panel is limited by number of light signal receivers and light signal emitters installed in the borders of the touch panel. To cover most regions of the touch panel with touch points, the borders of the touch panel must be filled with light signal emitters and light signal receivers, which severely reduces design flexibility of the optical touch monitor, not to mention the amount of space that must be reserved on the borders of the touch panel for installing the light signal emitters and light signal receivers. Further, the prior art also utilizes one light signal emitter for multiple light signal receivers, or one light signal receiver for multiple light signal emitters. However, this makes it impossible to utilize touch panel space efficiently.

### SUMMARY OF THE INVENTION

According to an embodiment, an optical touch display comprises a touch panel, at least one projection light source, at least one image sensor, an angle calculation module, a distance calculation module, and an object positioning module. The touch panel is contactable by at least one object and has a first predetermined axis. The at least one projection light source is for projecting at least one predetermined image comprising at least one predetermined pattern onto the touch panel, and forming at least one similar pattern on a surface of the object. The at least one image sensor is for capturing at least one reflection image comprising an image of the object. The at least one reflection image comprises the at least one similar pattern. The angle calculation module is for finding a line between an image sensor of the at least one image sensor and the object according to an image formation position of the object in the at least one reflection image for calculating a difference angle between the connecting line and the first predetermined axis. The distance calculation module is for comparing positions, dimensions and/or phases of a predetermined pattern of the at least one predetermined pattern and a similar pattern of the at least one similar pattern for calculating straight line distance of an image sensor between the at least one image sensor and the object. The object positioning module is for locating position coordinates of the object on the touch panel according to the difference angle and the straight line distance.

According to an embodiment, an optical touch display comprises a touch panel, at least one projection light source, at least one image sensor, an angle calculation module, a distance calculation module, and an object positioning module. The touch panel is contactable by at least one object. The at least one projection light source is for projecting a predetermined image comprising a pattern onto the touch panel, and forming the pattern on a surface of the object. The at least one image sensor is for capturing at least one reflection image comprising an image of the object. The at least one reflection image comprises the pattern. The angle calculation module is for finding a line between the image sensor and the object according to an image formation position of the object in the reflection image for calculating a difference angle between the connecting line and a first predetermined axis. The distance calculation module is for calculating time difference between emitting the predetermined image comprising the pattern and receiving the reflection image comprising the pattern for calculating straight line distance between the image sensor and the object. The object positioning module is for locating position coordinates of the object on the touch panel according to the difference angle and the straight line distance.

According to an embodiment, an optical touch display comprises a touch panel, at least one image sensor, an angle calculation module, a distance calculation module, and an object positioning module. The touch panel is contactable by at least one object. The at least one image sensor is for capturing at least one reflection image reflected by a surface of the object. The angle calculation module is for finding a connecting line between the image sensor and the object according to an image formation position of the object in the reflection image for calculating a difference angle between the connecting line and a predetermined axis of the touch panel. The distance calculation module is for calculating straight line distance between the image sensor and the object according to image formation size and/or image formation brightness of the object in the reflection image. The object positioning module is for locating position coordinates of the object on the touch panel according to the difference angle and the straight line distance.

According to an embodiment, an optical touch display comprises a touch panel, at least one image sensor, an ultrasound transceiver, an angle calculation module, a distance calculation module, and an object positioning module. The touch panel is contactable by at least one object. The least one image sensor is for capturing a reflection image reflected from a surface of the object. The ultrasound transceiver is for projecting an ultrasound signal onto the touch panel, and receiving an ultrasound reflection signal reflected from the object. The angle calculation module is for finding a line between the image sensor and the object according to an image formation position of the object in the reflection image for calculating a difference angle between the connecting line and a first predetermined axis. The distance calculation module is for calculating time difference between emitting the ultrasound signal and receiving the reflection image for calculating straight line distance between the ultrasound transceiver and the object. The object positioning module is for locating position coordinates of the object on the touch panel according to the difference angle and the straight line distance.

According to an embodiment, an optical touch display comprises a touch panel, a first projection light source, a second projection light source, a first image sensor, a second image sensor, a distance calculation module, and an object positioning module. The touch panel is contactable by at least one object. The first projection light source is for projecting a first predetermined image comprising a first predetermined pattern onto the touch panel, and forming a first similar pattern on a surface of the object. The second projection light source is for projecting a second predetermined image comprising a second predetermined pattern onto the touch panel, and forming a second similar pattern on a surface of the object. The first image sensor is for capturing a first reflection image comprising the first similar pattern of the object. The second image sensor is for capturing a second reflection image comprising the second similar pattern of the object. The distance calculation module is for comparing positions, dimensions and/or phases of the first similar pattern of the first reflection image, the second similar pattern of the second reflection image, the first predetermined image, and the second predetermined image for calculating straight line distance between the object and the first image sensor, and straight line distance between the object and the second image sensor. The object positioning module is for locating position coordinates of the object on the touch panel according to the straight line distance between the object and the first image sensor, and the straight line distance between the object and the second image sensor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a diagram of an optical touch display according to an embodiment.

FIG. 1B is a diagram of an optical touch display according to another embodiment.

FIG. 2 is a diagram illustrating the first projection light source and the first image sensor located in an opposite corner of the touch panel from the second projection light source and the second image sensor.

FIG. 3A and FIG. 3B are diagrams illustrating relationship between a coded pattern projected onto an object and distance between the object and the second image sensor.

FIG. 4A and FIG. 4B are diagrams illustrating relationship between a speckle pattern projected onto the object and distance between the object and the second image sensor.

FIG. 5A and FIG. 5B are diagrams illustrating the object positioning module locating position coordinates on the touch panel of the object according to an angle and the straight line distance.

FIG. 6 is a diagram of an optical touch display according to another embodiment.

FIG. 7 is a diagram illustrating having the first projection light source and the first image sensor located in a different corner of the touch panel from the second projection light source and the second image sensor.

FIG. 8 is a diagram of an optical touch display according to another embodiment.

FIG. 9A and FIG. 9B are diagrams illustrating relationship between size of the object image in the second reflection image and distance between the object and the second image sensor.

FIG. 10 is a diagram illustrating the first projection light source and the first image sensor located in a corner of the touch panel opposite from the second projection light source and the second image sensor.

FIG. 11 is a diagram of an optical touch display according to another embodiment.

FIG. 12 is a diagram illustrating having the projection light source and the image sensor located in a corner of the touch panel opposite from the ultrasound transceiver.

FIG. 13 is a diagram of an optical touch display according to another embodiment.

### DETAILED DESCRIPTION

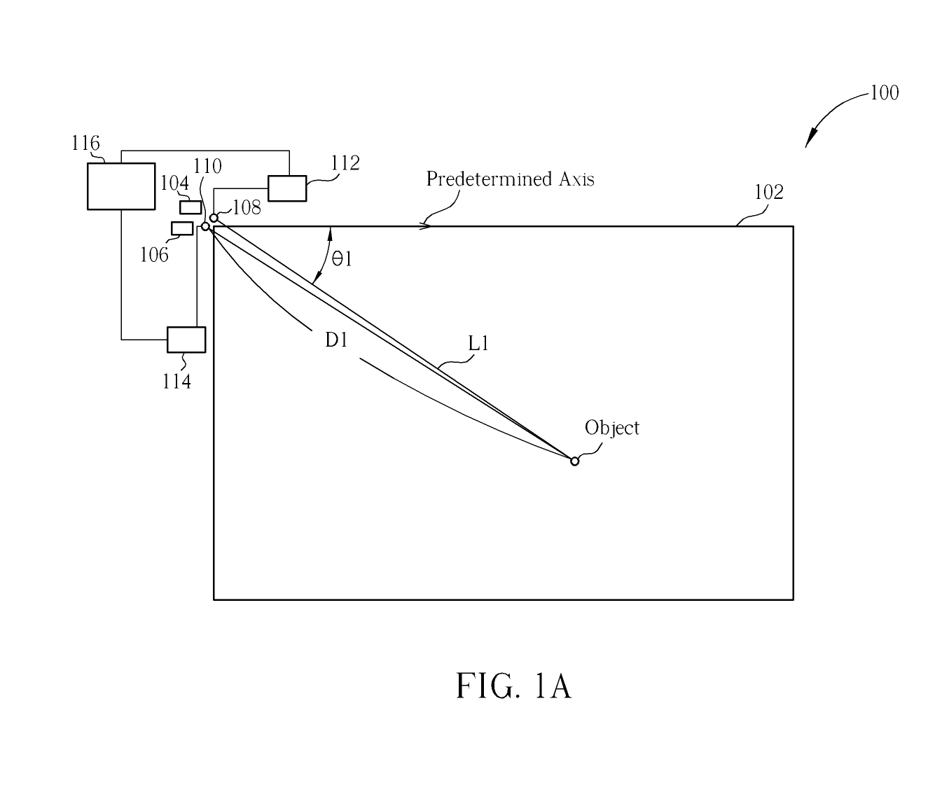

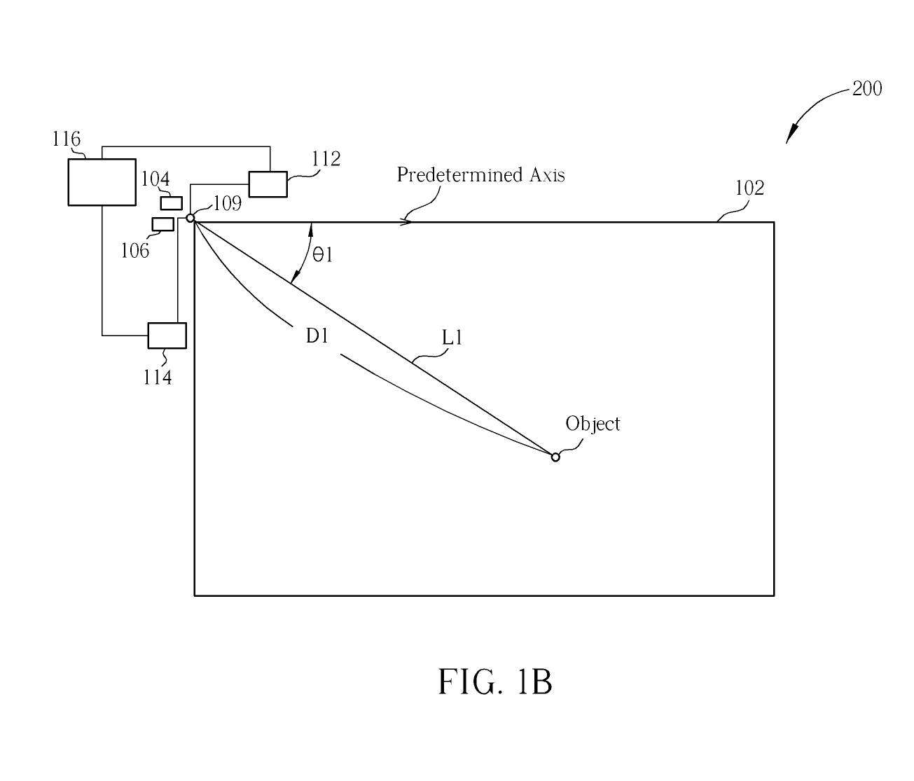

Please refer to FIG. 1A, which is a diagram of an optical touch display 100 according to an embodiment. The optical touch display 100 comprises a touch panel 102, a first projection light source 104, a second projection light source 106, a first image sensor 108, a second image sensor 110, an angle calculation module 112, a distance calculation module 114, and an object positioning module 116. The touch panel 102 is utilized for providing contact by an object, and has a predetermined axis parallel to an upper edge of the touch panel 102. The predetermined axis is utilized for defining angularity, and is not limited to being parallel to the upper edge of the touch panel 102, but may also be parallel to a lower edge, a left edge, or a right edge of the touch panel 102. The first projection light source 104 is utilized for projecting infrared light onto the touch panel 102, and is preferably an infrared light source, but the first projection light source 104 is not limited to being an infrared light source, and may also be a visible light source, or an ultraviolet light source. The first image sensor 108 is preferably an infrared image sensor for capturing infrared light, and filtering out the effect of other types of light (such as visible light) on the optical touch display 100. When the first projection light source 104 projects infrared light onto the touch panel 102, the first image sensor captures a first reflection image comprising infrared light reflected from an object. The second projection light source 106 may emit monotone, narrow spectrum light (such as laser light) for projecting a predetermined image comprising a predetermined pattern onto the touch panel 102, and forming a similar pattern on a surface of the object. The predetermined pattern may be a speckle pattern or a coded pattern. The second image sensor 110 is utilized for capturing a second reflection image comprising a similar pattern formed on a surface of the object by the second projection light source 106. The angle calculation module 112 is coupled to the first image sensor 108 for finding a line L1 between the first image sensor 108 or the second image sensor 110 and the object according to an image formation position of the object in the first reflection image captured by the first image sensor 108, and calculating an angle θ1 between the line L1 and the predetermined axis. The distance calculation module 114 is coupled to the second image sensor 110 for comparing positions, dimensions and/or phases of the predetermined pattern and the similar pattern in the second reflection image for calculating straight line distance D1 between the second image sensor 110 and the object. The object positioning module 116 is coupled to the distance calculation module 114 and the angle calculation module 112 for locating position coordinates of the object on the touch screen according to the angle θ1 and the straight line distance D1. The first projection light source 104, the second projection light source 106, the first image sensor 108, and the second image sensor 110 are all located at a same corner of the touch panel 102.

Please refer to FIG. 1B, which is a diagram of an optical touch display 200 according to another embodiment. The optical touch display 200 is different from the optical touch display 100 in that the first image sensor 108 and the second image sensor 110 are combined to form an image sensor group 109, and the image sensor group 109 is coupled to the angle calculation module 112 and the distance calculation module 114. Remaining components of the optical touch display 200 have the same operating principle as those of the optical touch display 100.

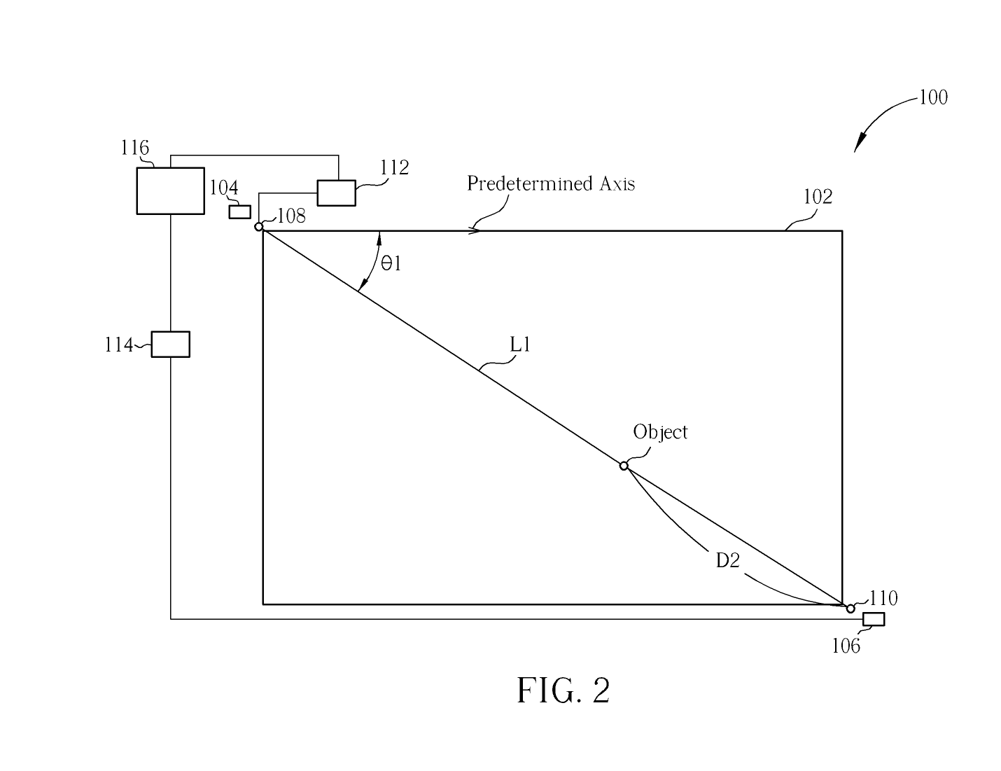

The embodiment shown in FIG. 1A is not limited to only using two projection light sources 104, 106 and two image sensors 108, 110. And, the embodiment shown in FIG. 1A is not limited to having the first projection light source 104, the second projection light source 106, the first image sensor 108, and the second image sensor 110 all in the same corner of the touch panel 102. Please refer to FIG. 2, which is a diagram illustrating the first projection light source 104 and the first image sensor 108 located in an opposite corner of the touch panel 102 from the second projection light source 106 and the second image sensor 110.

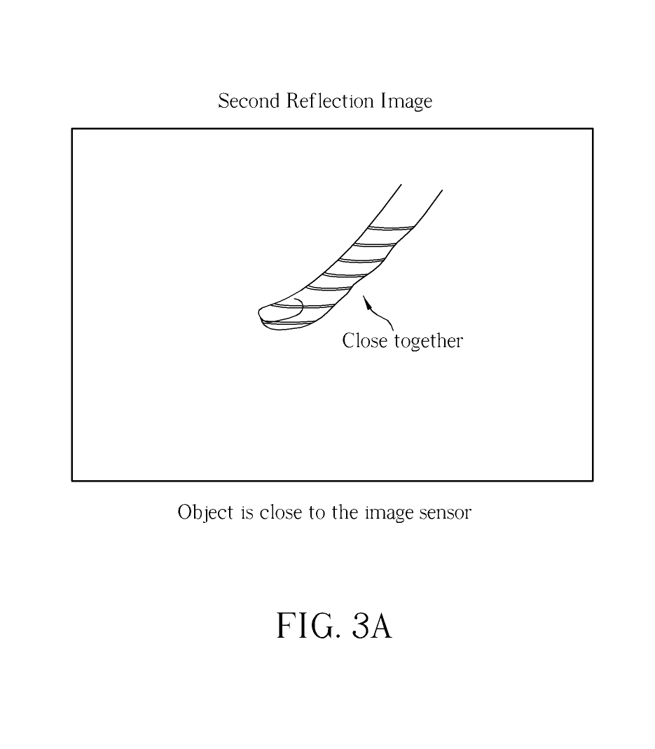

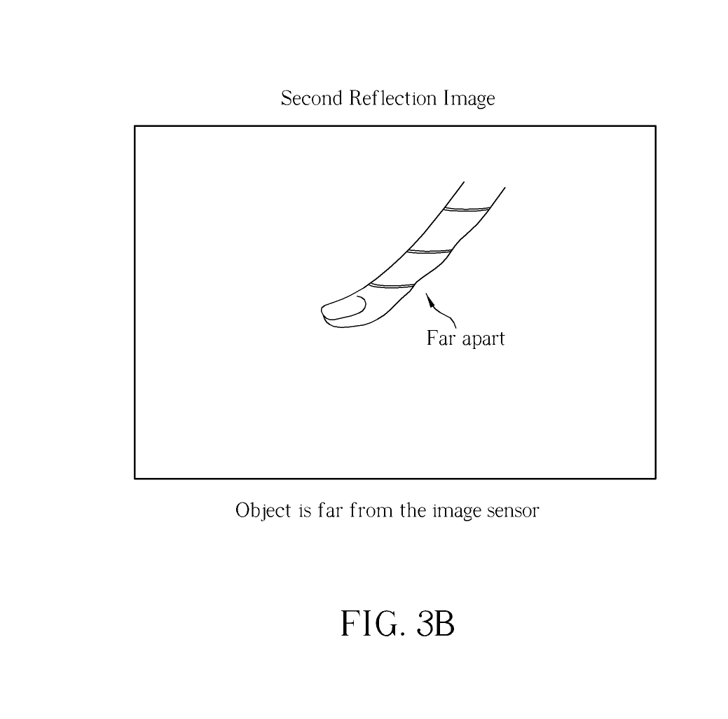

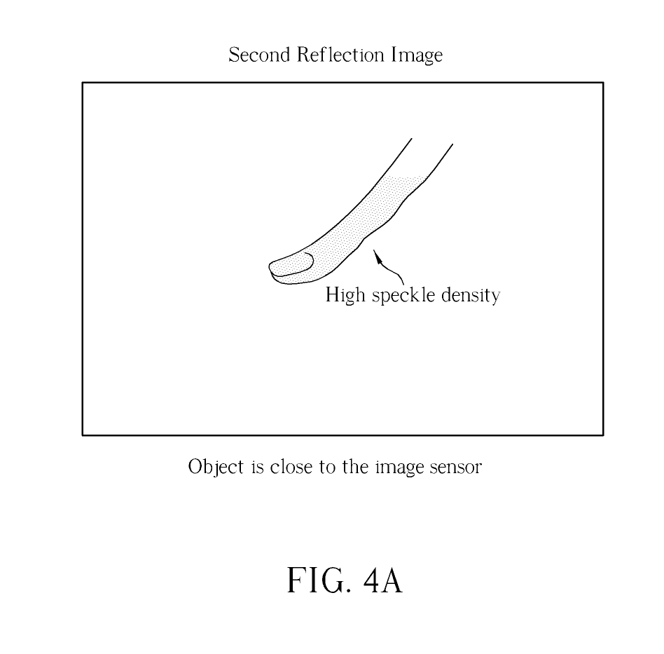

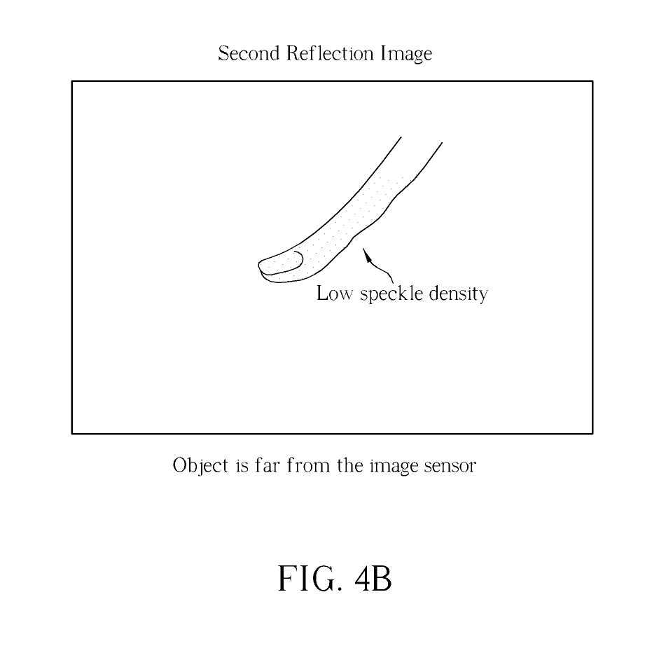

Please refer to FIG. 3A, FIG. 3B, FIG. 4A, and FIG. 4B. FIG. 3A and FIG. 3B are diagrams illustrating relationship between a coded pattern projected onto an object and distance between the object and the second image sensor 110. As shown in FIG. 3A and FIG. 3B, for different distances between the object and the second image sensor 110, separation or image formation position of the coded pattern projected onto the object is different. Thus, the distance calculation module 114 may utilize an image processing algorithm to determine spatial phase information, then calculate straight line distance D1 between the second image sensor 110 and the object based on the spatial phase information. FIG. 4A and FIG. 4B are diagrams illustrating relationship between a speckle pattern projected onto the object and distance between the object and the second image sensor 110. As shown in FIG. 4A and FIG. 4B, for different distances between the object and the second image sensor 110, speckle density or position of the speckle pattern projected onto the object is different. Thus, the distance calculation module 114 may utilize a speckle pattern spatial summation characteristic analysis algorithm to find straight line distance D1 between the object and the second image sensor 110.

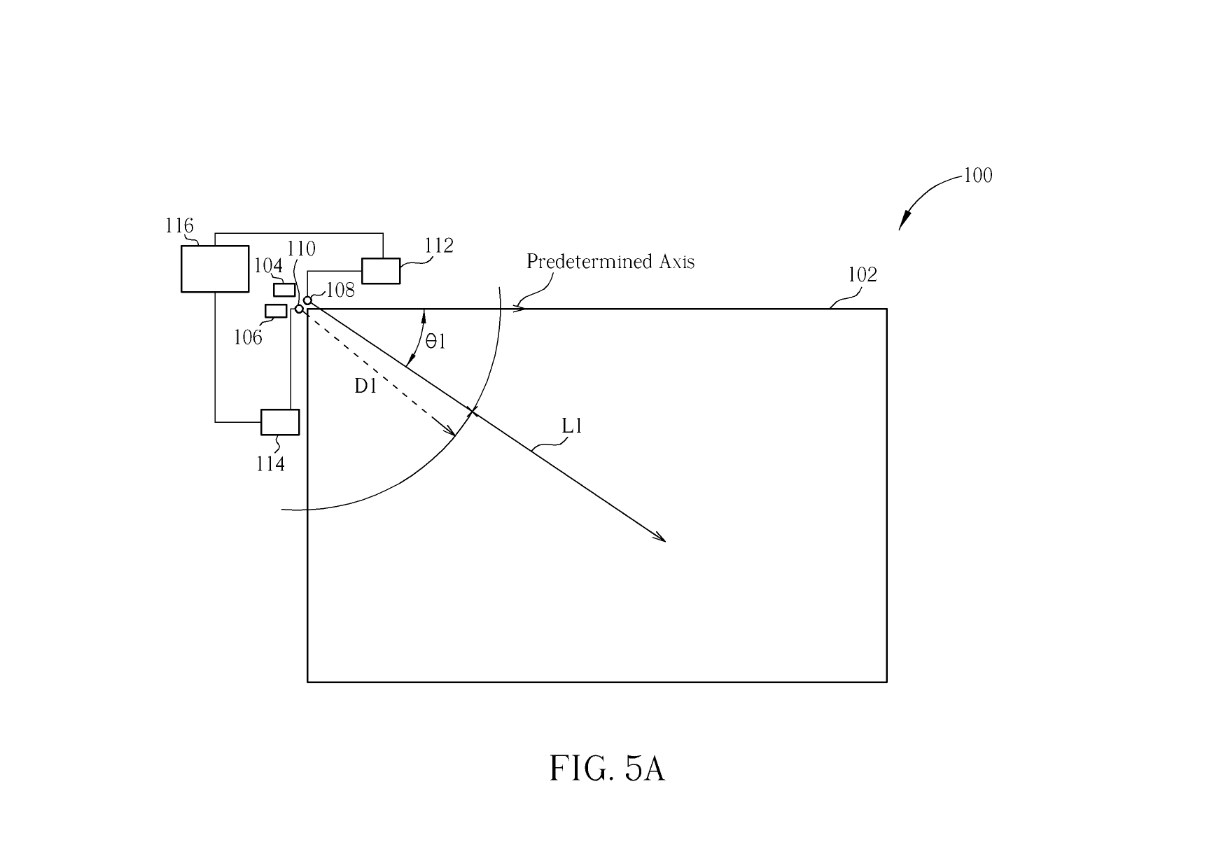

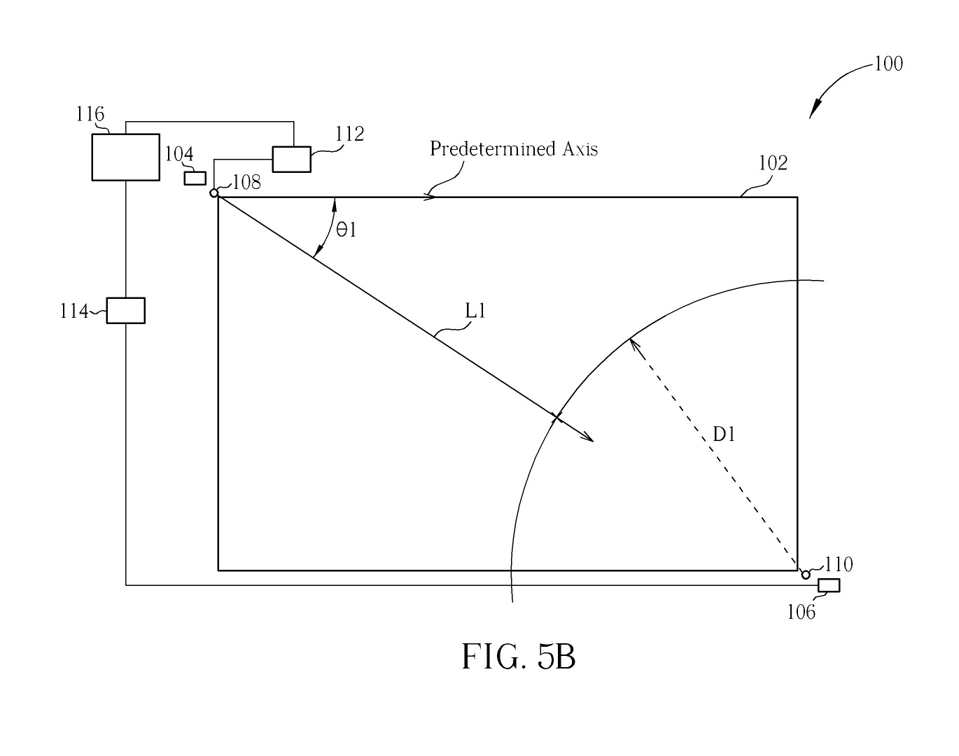

Please refer to FIG. 5A and FIG. 5B, which are diagrams illustrating the object positioning module 116 locating position coordinates on the touch panel 102 of the object according to an angle θ1 and the straight line distance D1. As shown in FIG. 5A and FIG. 5B, the straight line distance D1 is taken as a radius for drawing a circular arc having the second image sensor 110 as its center. A line L1 at the angle θ1 from a predetermined axis intersects the circular arc at a point X. The object positioning module 116 locates the position coordinates of the object on the touch panel 102 according to point X of intersection between the line L1 and the circular arc.

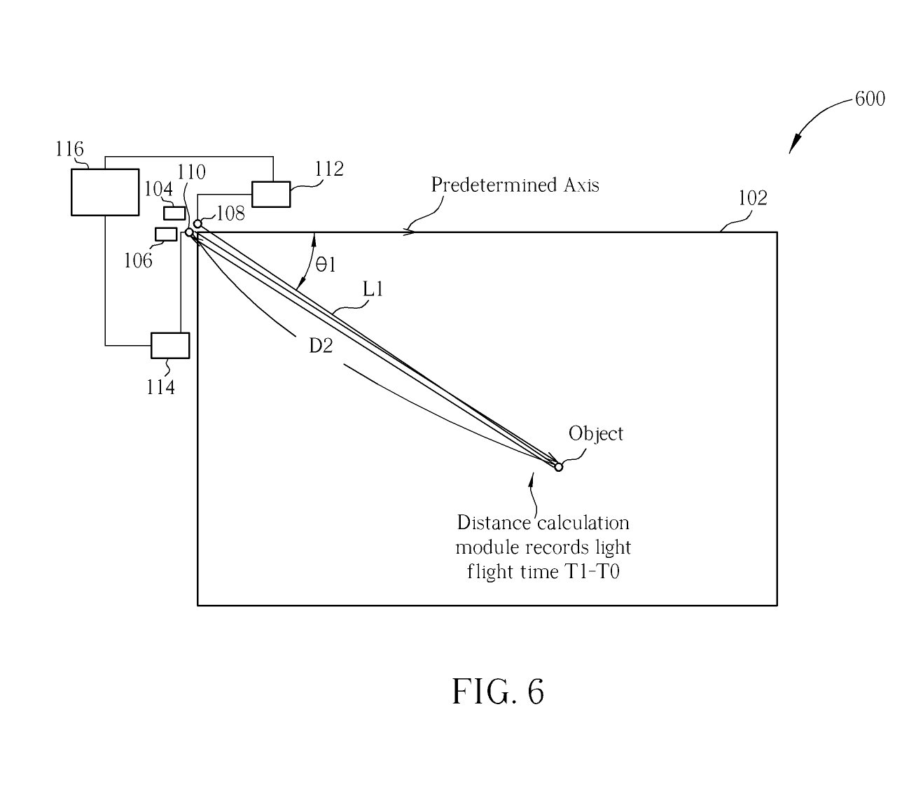

Please refer to FIG. 6, which is a diagram of an optical touch display 600 according to another embodiment. The optical touch display 600 comprises a touch panel 602, a first projection light source 604, a second projection light source 606, a first image sensor 608, a second image sensor 610, an angle calculation module 612, a distance calculation module 614, and an object positioning module 616. The embodiment shown in FIG. 6 is different from the embodiment shown in FIG. 1 in that the distance calculation module 614 of the embodiment shown in FIG. 6 records a time difference (T1−T0) between emitting time T0 when a predetermined image comprising pattern information is emitted and receiving time T1 when a second reflection image comprising the pattern information is received. The distance calculation module 614 uses the speed of light and the time difference (T1−T0) to calculate straight line distance D2 between the object and the second image sensor 610. Other operating principles of the optical touch display 600 are the same as those of the optical touch display 100, and are not further described here.

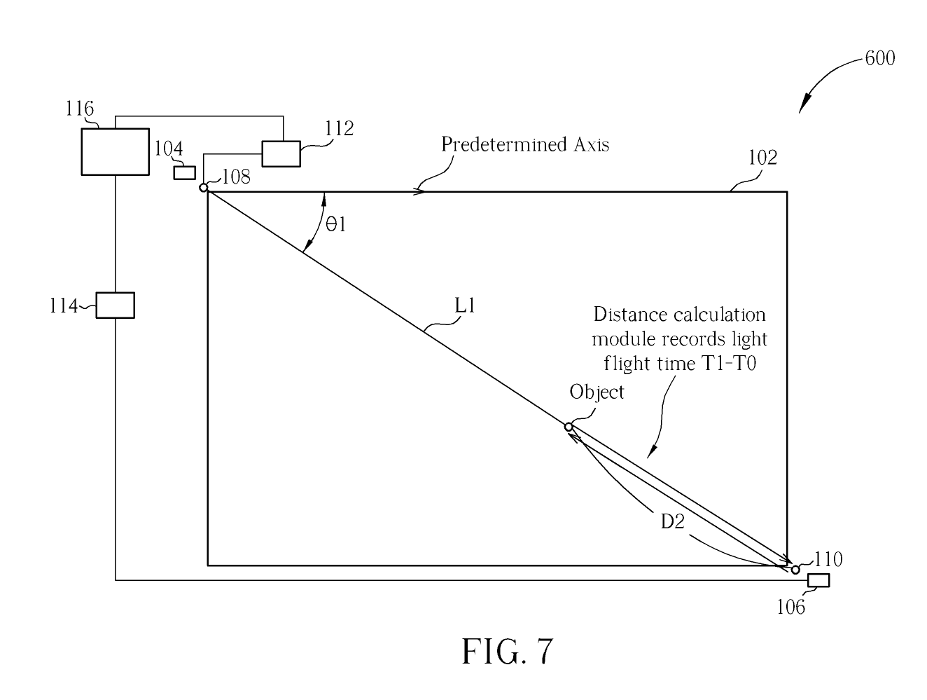

The embodiment shown in FIG. 6 is not limited to only using two projection light sources 604, 606 and two image sensors 608, 610. The embodiment shown in FIG. 6 is not limited to having the first projection light source 604, the second projection light source 606, the first image sensor 608, and the second image sensor 610 all in the same corner of the touch panel 602. Please refer to FIG. 7, which is a diagram illustrating having the first projection light source 604 and the first image sensor 608 located in a different corner of the touch panel 602 from the second projection light source 606 and the second image sensor 610.

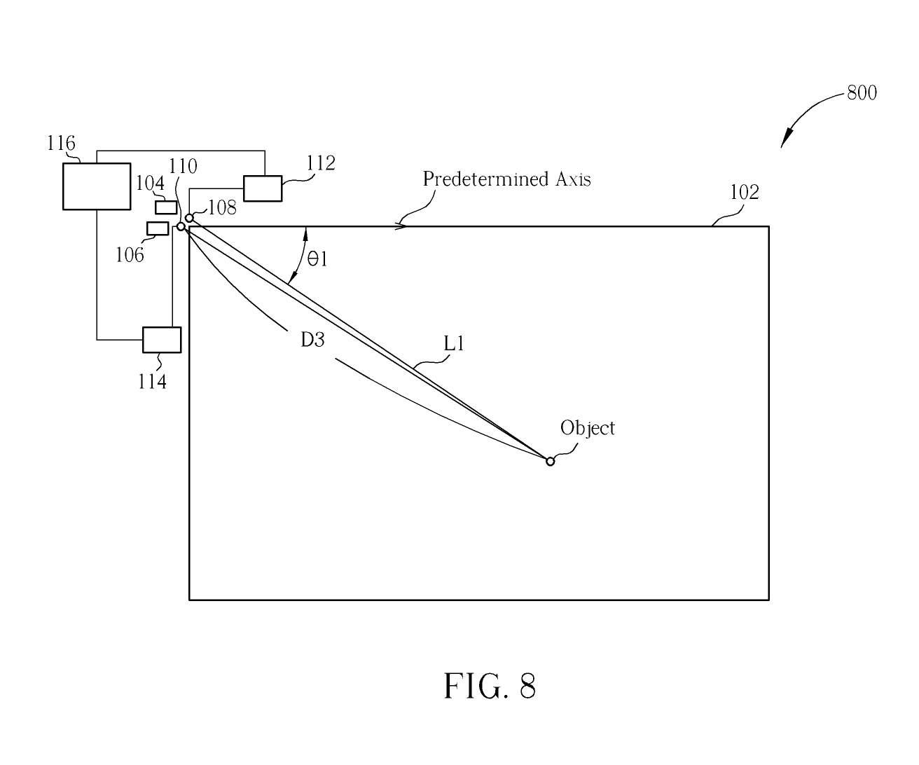

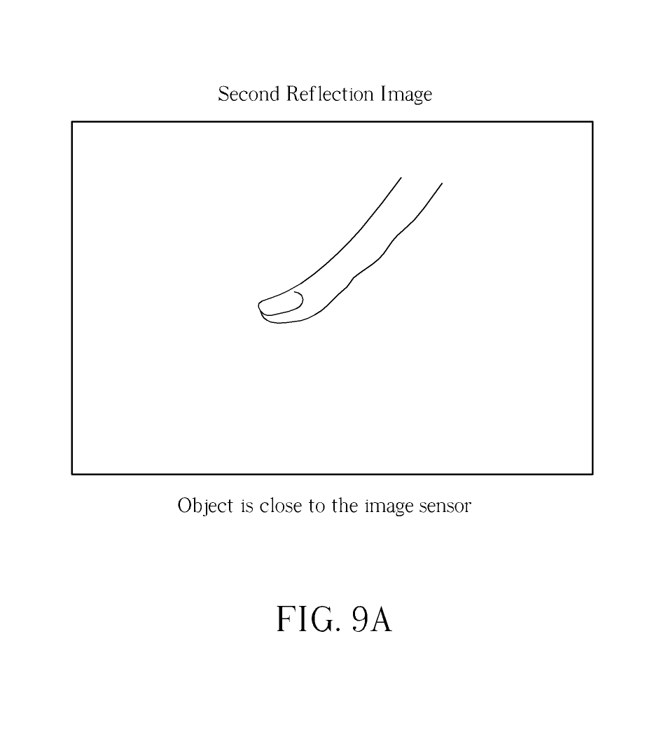

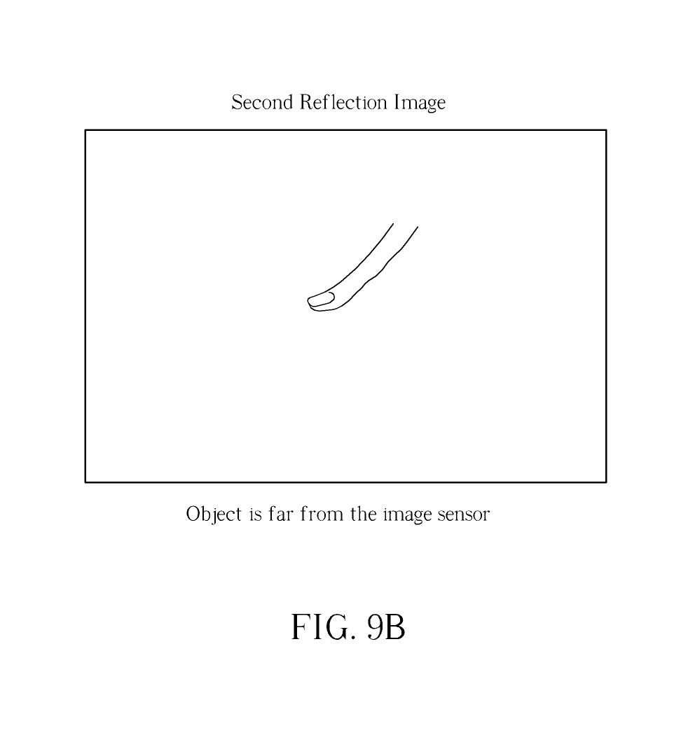

Please refer to FIG. 8, which is a diagram of an optical touch display 800 according to another embodiment. The optical touch display 800 comprises a touch panel 802, a first projection light source 804, a second projection light source 806, a first image sensor 808, a second image sensor 810, an angle calculation module 812, a distance calculation module 814, and an object positioning module 816. The embodiment shown in FIG. 8 is different from the embodiment shown in FIG. 1 in that the second projection light source 806 and the first projection light source 804 are both infrared light sources, and the second image sensor 810 is an infrared light sensor. The second image sensor 810 is for capturing a second reflection image comprising object image information. The distance calculation module 814 coupled to the second image sensor 810 is for using a characteristic that size and/or brightness or position of the object image vary with distance between the object and the second image sensor 810 to calculate straight line distance D3 between the second image sensor 810 and the object. Please refer to FIG. 9A and FIG. 9B, which are diagrams illustrating relationship between size of the object image in the second reflection image and distance between the object and the second image sensor 810. As shown in FIG. 9A and FIG. 9B, size of the object image in the second reflection image varies with distance between the object and the second image sensor. When the object is closer to the second image sensor 810, the object image in the second reflection image is brighter. When the object is further from the second image sensor 810, the object image in the second reflection image is dimmer. Thus, the straight line distance D3 between the second image sensor 810 and the object may be calculated based on the above described properties. Other than the described differences, operating principles of the optical touch display 800 are the same as those of the optical touch display 100, and are not further described here.

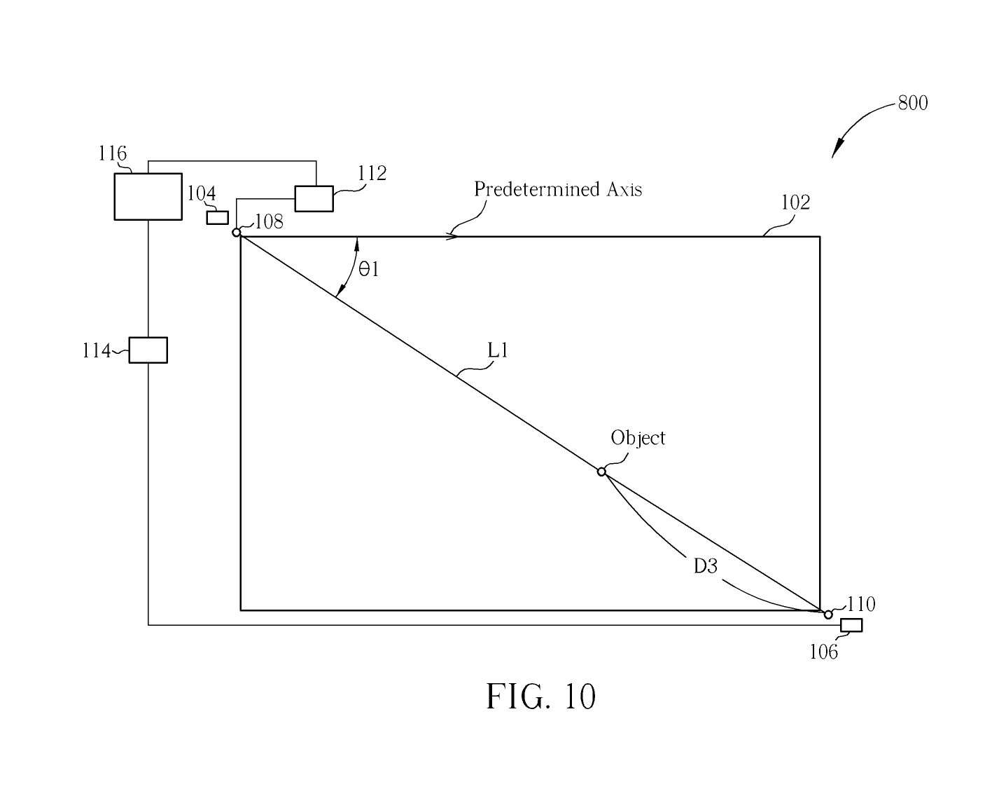

The embodiment shown in FIG. 8 is not limited to using two projection light sources 804, 806 and two image sensors 808, 810. The embodiment shown in FIG. 8 is not limited to having the first projection light source 804, the second projection light source 806, the first image sensor 808, and the second image sensor 810 all located in the same corner of the touch panel 802. Please refer to FIG. 10, which is a diagram illustrating the first projection light source 804 and the first image sensor 808 located in a corner of the touch panel 802 opposite from the second projection light source 806 and the second image sensor 810.

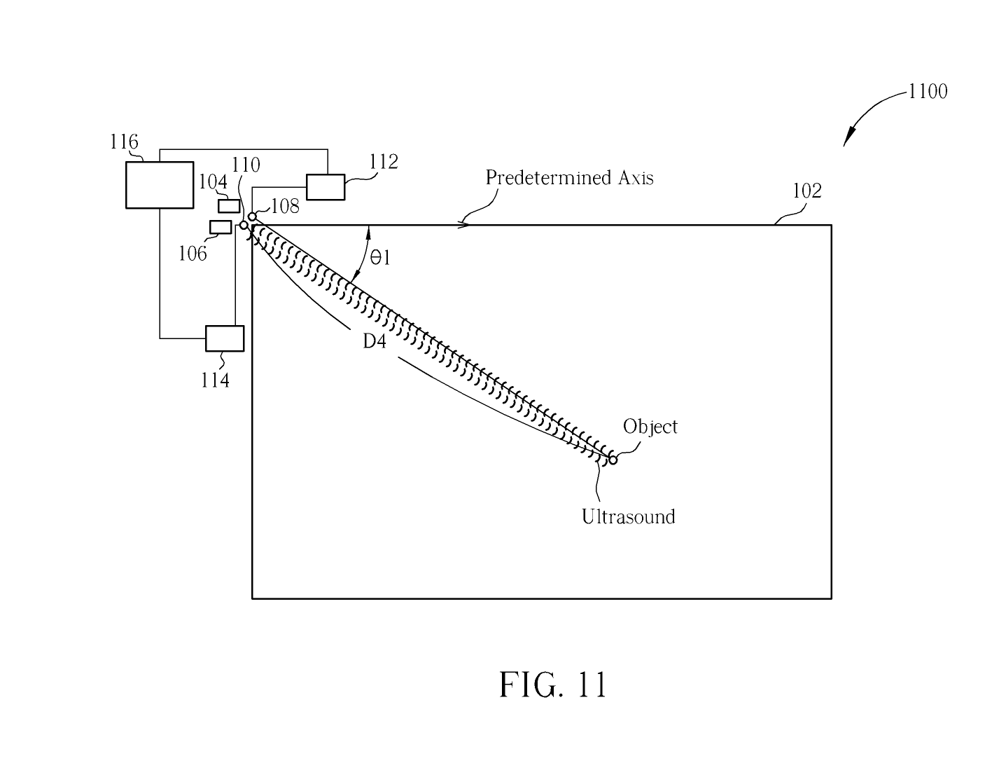

Please refer to FIG. 11, which is a diagram of an optical touch display 1100 according to another embodiment. The optical touch display 1100 comprises a touch panel 1102, a projection light source 1104, an image sensor 1106, an ultrasound transceiver 1108, an angle calculation module 1110, a distance calculation module 1112, and an object positioning module 1114. In the embodiment shown in FIG. 11, the ultrasound transceiver 1108 projects an ultrasound signal onto the touch panel 1102, and receives an ultrasound reflection signal reflected by an object. The distance calculation module 1112 coupled to the ultrasound transceiver 1108 records a time difference (U1-U0) between emission time U0 when the ultrasound signal is emitted and reception time U1 when the ultrasound reflection signal is received. Then, the distance calculation module 1112 utilizes ultrasound wave velocity and the time difference (U1−U0) to calculate straight line distance D4 between the ultrasound transceiver 1108 and the object. Other operating principles of the optical touch display 1100 are the same as those of the optical touch display 100, and are not further described here. The embodiment shown in FIG. 11 is not limited to using only one projection light source 1104, one image sensor 1106, and one ultrasound transceiver 1108.

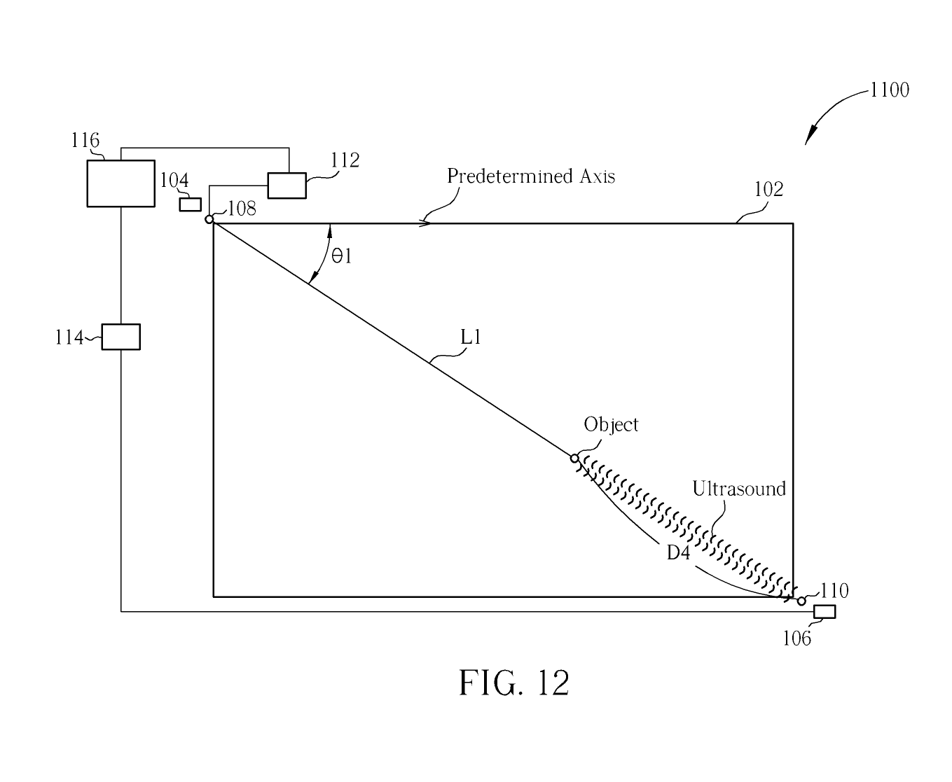

The embodiment shown in FIG. 11 is not limited to having the projection light source 1104, the image sensor 1106, and the ultrasound transceiver 1108 located in the same corner of the touch panel 1102. Please refer to FIG. 12, which is a diagram illustrating having the projection light source 1104 and the image sensor 1106 located in a corner of the touch panel 1102 opposite from the ultrasound transceiver 1108.

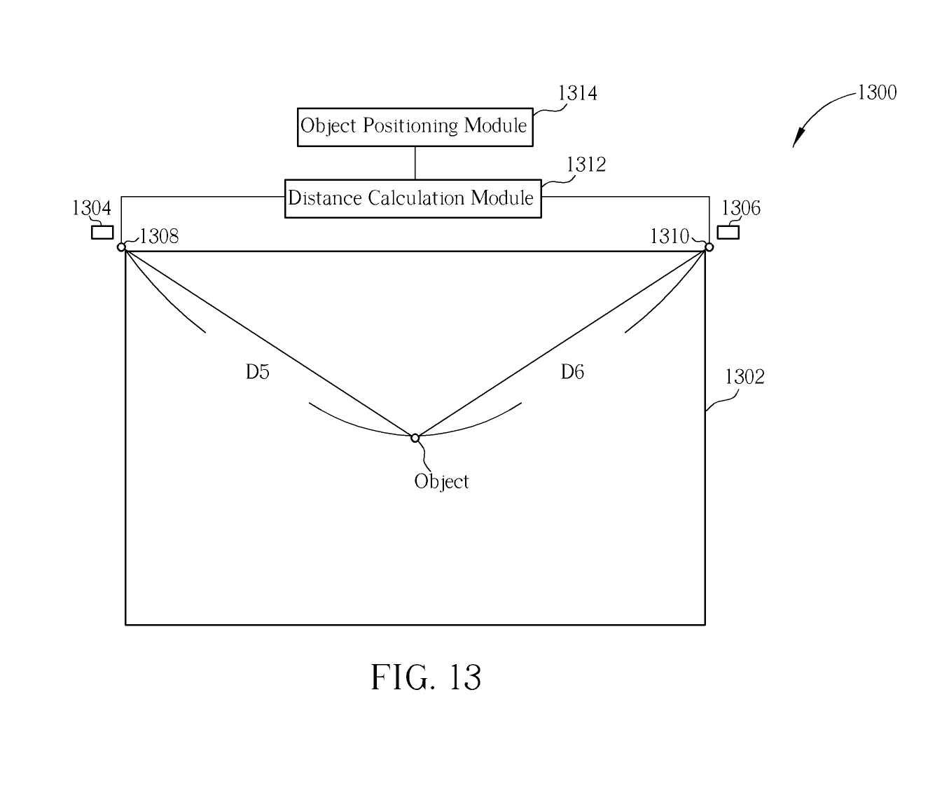

Please refer to FIG. 13, which is a diagram of an optical touch display 1300 according to another embodiment. The optical touch display 1300 comprises a touch panel 1302, a first projection light source 1304, a second projection light source 1306, a first image sensor 1308, a second image sensor 1310, a distance calculation module 1312, and an object positioning module 1314. The embodiment shown in FIG. 13 is different from the embodiment shown in FIG. 1A in that the first projection light source 1304 and the second projection light source 1306 emit monochromatic narrow-wavelength light, such as laser light, for projecting a first predetermined image comprising a first predetermined pattern and a second predetermined image comprising a second predetermined pattern onto the touch panel 1302, and forming a first similar pattern and a second similar pattern on a surface of an object. The first predetermined pattern and the second predetermined pattern may be a speckle pattern or a coded pattern. The first image sensor 1308 is utilized for capturing a first reflection image comprising the first similar pattern formed on the surface of the object by the first projection light source 1304. The second image sensor 1310 is utilized for capturing a second reflection image comprising the second similar pattern formed on the surface of the object by the second projection light source 1306. The distance calculation module 1312 is coupled to the first image sensor 1308 and the second image sensor 1310 for comparing positions, dimensions and/or phases of the first similar pattern of the first reflection image, the second similar pattern of the second reflection image, the first predetermined image, and the second predetermined image, for calculating straight line distances D5, D6 between the object and the first image sensor 1308 and the second image sensor 1310, respectively. The object positioning module 1314 is coupled to the distance calculation module 1312 for locating position coordinates of the object on the touch panel 1302 according to the straight line distances D5, D6. Other operating principles of the optical touch display 1300 are the same as those of the optical touch display 100, and are not described again here. The first projection light source 1304 and the first image sensor 1308 may be located on opposite corners of the touch panel 1302 from the second projection light source 1306 and the second image sensor 1310.

In the above, the optical touch display that utilizes the first projection light source, the first image sensor, and the angle calculation module to calculate the difference angle between the straight line connecting the object to the first image sensor and the predetermined axis is provided. The optical touch display utilizes the second projection light source, the second image sensor, and the distance calculation module to calculate the straight line distance between the object and the second image sensor, or utilizes the ultrasound transceiver and the distance calculation module to calculate the straight line distance between the object and the ultrasound transceiver. The optical touch display may also utilize the first projection light source, the first image sensor, the second projection light source, the second image sensor, and the distance calculation module to calculate the straight line distances between the object and the first image sensor and the second image sensor, respectively. The object positioning module locates position coordinates of the object on the touch panel according to the difference angle and the straight line distance, or according to the straight line distances between the object and the first image sensor and the second image sensor, respectively. Thus, the optical touch display is not only responsive to touch input over the entirety of the touch panel, but also has the advantage of greater design flexibility.

Those skilled in the art will readily observe that numerous modifications and alterations of the device and method may be made while retaining the teachings of the invention.

What is claimed is:

1. An optical touch display comprising:
a touch panel contactable by at least one object, the touch panel having a first predetermined axis;
at least one projection light source for projecting at least one predetermined image comprising at least one predetermined pattern onto the touch panel, and forming at least one similar pattern on a surface of the object;
at least one image sensor for capturing at least one reflection image comprising an image of the object, wherein the at least one reflection image comprises the at least one similar pattern;
an angle calculation module, for finding a line between an image sensor of the at least one image sensor and the object according to an image formation position of the object in the at least one reflection image for calculating a difference angle between the connecting line and the first predetermined axis;
a distance calculation module for comparing positions, dimensions and/or phases of a predetermined pattern of the at least one predetermined pattern and a similar pattern of the at least one similar pattern for calculating straight line distance of an image sensor between the at least one image sensor and the object; and
an object positioning module for locating position coordinates of the object on the touch panel according to the difference angle and the straight line distance.

2. The optical touch display of claim 1, wherein the predetermined pattern is a speckle pattern or a coded pattern.

3. The optical touch display of claim 1, wherein the at least one image sensor comprises a first image sensor and a second image sensor, the first image sensor captures a first reflection image utilized by the angle calculation module in calculating the difference angle, and the second image sensor captures a second reflection image utilized by the distance calculation module in calculating the straight line distance.

4. The optical touch display of claim 3, wherein the first image sensor is an infrared image sensor for capturing infrared light, and a projection light source of the at least one projection light source is an infrared light source for projecting infrared light onto the touch panel for the first image sensor to capture the first reflection image comprising an image of the object.

5. The optical touch display of claim 3, wherein a projection light source of the at least one projection light source is capable of emitting monochromatic narrow-wavelength light, and the second image sensor is utilized for capturing the second reflection image comprising a similar pattern formed on the object surface by the projection light source.

6. An optical touch display comprising:
a touch panel contactable by at least one object;
at least one projection light source for projecting a predetermined image comprising a pattern onto the touch panel, and forming the pattern on a surface of the object;
at least one image sensor for capturing at least one reflection image comprising an image of the object, wherein the at least one reflection image comprises the pattern;
an angle calculation module, for finding a line between the image sensor and the object according to an image formation position of the object in the reflection image for calculating a difference angle between the connecting line and a first predetermined axis;
a distance calculation module for calculating time difference between emitting the predetermined image comprising the pattern and receiving the reflection image comprising the pattern for calculating straight line distance between the image sensor and the object; and
an object positioning module for locating position coordinates of the object on the touch panel according to the difference angle and the straight line distance.

7. The optical touch display of claim 6, wherein the at least one image sensor comprises a first image sensor and a second image sensor, the first image sensor is for capturing a first reflection image for the angle calculation module to calculate the difference angle, and the second image sensor is for capturing a second reflection image for the distance calculation module to calculate the straight line distance.

8. The optical touch display of claim 7, wherein the first image sensor is an infrared image sensor for capturing infrared light, and further providing an infrared light source for projecting infrared light onto the touch panel for the first image sensor to capture the first reflection image comprising image formation information of the object.

9. The optical touch display of claim 7, wherein the projection light source is capable of emitting monochromatic narrow-wavelength light, and the second image sensor is utilized for capturing the second reflection image comprising the pattern formed on the object surface by the projection light source.

10. An optical touch display comprising:
a touch panel contactable by at least one object;
at least one image sensor for capturing at least one reflection image reflected by a surface of the object;
an angle calculation module for finding a connecting line between the image sensor and the object according to an image formation position of the object in the reflection image for calculating a difference angle between the connecting line and a predetermined axis of the touch panel;
a distance calculation module for calculating straight line distance between the image sensor and the object according to image formation size and/or image formation brightness of the object in the reflection image; and
an object positioning module for locating position coordinates of the object on the touch panel according to the difference angle and the straight line distance.

11. The optical touch display of claim 10, wherein the at least one image sensor comprises a first image sensor and a second image sensor, the first image sensor captures a first reflection image utilized by the angle calculation module in calculating the difference angle, and the second image sensor captures a second reflection image utilized by the distance calculation module in calculating the straight line distance.

12. The optical touch display of claim 11, wherein the first image sensor is an infrared image sensor for capturing infrared light, and further provides an infrared light source for projecting infrared light onto the touch panel for the first image sensor to capture the first reflection image comprising image formation information of the object.

13. The optical touch display of claim 11, wherein the second image sensor is an infrared image sensor for capturing infrared light, and further providing an infrared light source for projecting infrared light onto the touch panel for the second image sensor to capture the second reflection image comprising image formation information of the object.

14. An optical touch display comprising:
a touch panel contactable by at least one object;
at least one image sensor for capturing a reflection image reflected from a surface of the object;
an ultrasound transceiver for projecting an ultrasound signal onto the touch panel, and receiving an ultrasound reflection signal reflected from the object;
an angle calculation module for finding a line between the image sensor and the object according to an image formation position of the object in the reflection image for calculating a difference angle between the connecting line and a first predetermined axis;
a distance calculation module for calculating time difference between emitting the ultrasound signal and receiving the reflection image for calculating straight line distance between the ultrasound transceiver and the object; and
an object positioning module for locating position coordinates of the object on the touch panel according to the difference angle and the straight line distance.

15. The optical touch display of claim 14, wherein the image sensor is an infrared image sensor for capturing infrared light, and further provides an infrared light source for projecting infrared light onto the touch panel for the image sensor to capture the reflection image comprising image formation information of the object.

16. An optical touch display comprising:
a touch panel contactable by at least one object;
a first projection light source for projecting a first predetermined image comprising a first predetermined pattern onto the touch panel, and forming a first similar pattern on a surface of the object;
a second projection light source for projecting a second predetermined image comprising a second predetermined pattern onto the touch panel, and forming a second similar pattern on a surface of the object;
a first image sensor for capturing a first reflection image comprising the first similar pattern of the object;
a second image sensor for capturing a second reflection image comprising the second similar pattern of the object;
a distance calculation module for comparing positions, dimensions and/or phases of the first similar pattern of the first reflection image, the second similar pattern of the second reflection image, the first predetermined image, and the second predetermined image for calculating straight line distance between the object and the first image sensor, and straight line distance between the object and the second image sensor; and
an object positioning module for locating position coordinates of the object on the touch panel according to the straight line distance between the object and the first image sensor, and the straight line distance between the object and the second image sensor.

17. The optical touch display of claim 16, wherein the first predetermined patter and the second predetermined pattern are speckle patterns or coded patterns.

18. The optical touch display of claim 16, wherein the first projection light source and the second projection light source are capable of emitting monochromatic narrow-wavelength light.
